(19) United States
(12) Patent Application Publication
(10) Pub. No.: US 2019/0241420 A1
(43) Pub. Date: Aug. 8, 2019

(54) Dispensing Appliance for the Control of Froth Formation during Dispensing of a Malt Based Fermented Beverage (MBFB) Produced in Situ by Mixing an MBFB Concentrate with a Carbonated Diluent

(71) Applicant: Anheuser-Busch InBev S.A.

(72) Inventors: Daniel Peirsman, Leuven (BE); Lieven Dirx, Leuven (BE)

(21) Appl. No.: 16/345,667

(22) PCT Filed: Oct. 26, 2017
(86) PCT No.: PCT/EP2017/077423

§ 371 Date: Apr. 26, 2019

(30) Foreign Application Priority Data
Oct. 28, 2016 (EP) 16196358.2

(51) Int. Cl. B67D 1/00; B67D 1/12; B01F 5/06; B67D 1/04

(52) U.S. Cl. CPC B67D 1/0051; B67D 1/1272; B67D 1/04; B01F 5/068; B67D 1/008; B67D 1/0021

(57) ABSTRACT

A dispensing appliance prepares and dispenses a malt based fermented beverage (MBFB) by mixing an MBFB concentrate with a carbonated diluent. The dispensing appliance has a mixing chamber for mixing the MBFB concentrate and the carbonated diluent. The mixing chamber is defined by walls and is divided by a mid-plane normal to a longitudinal axis, X, into an upper portion and a lower portion. The mixing chamber has (a) a concentrate opening located in the upper portion and is provided with a fixing device for fixing a container containing an MBFB concentrate, (b) a diluent opening located in the upper portion and provided with a diluent connection to a source of carbonated diluent, (c) an outlet oriented parallel to the longitudinal axis and located in the lower portion, for discharging an MBFB composed of a mixture of MBFB concentrate and carbonated diluent, (d) a core defined by a core surface and mounted in the chamber such the core surface defines with the walls of the chamber a flow passage of width, w, measured normal to the core surface. The core is movingly mounted in the chamber, such that it can be translated along the longitudinal axis in order to control the width of portions of the flow passage.

### TECHNICAL FIELD

The present invention relates to a beverage dispensing appliance for in situ forming and dispensing a malt based fermented beverage (MBFB) by mixing a carbonated liquid diluent with a MBFC concentrate. The level of froth formed by the thus formed MBFC upon dispensing can be controlled very easily.

### BACKGROUND FOR THE INVENTION

In recent years, home dispensing appliances for domestic use have become very popular. Smaller containers ranging between 1.5 and 12 litres are now produced by many breweries and are readily available in shops. The reduction of the kegs volumes for domestic use compared with kegs used in pubs result in a substantial increase of the cost of the packaging per unit volume of beer.

Furthermore, there is presently a trend to fancier kinds of beverages, wherein multiple beverage components or beverages are added to one another so that consumers can create at home their own compositions adapted to their tastes. This trend also applies to fermented beverages, such as malt based fermented beverages (MBFB), like beers of various flavours and types.

One way, on the one end, of reducing the cost of packaging per unit volume of beer, and, on the other hand, of offering the consumers a large palette of compositions, is to provide containers filled with MBFB concentrates which can be used alone or admixed with one another and diluted with a liquid diluent. The containers can be in the form of unit doses such as capsule or a pad. By mixing such MBFB concentrates with a liquid diluent a desired beverage can be created in situ and simultaneously served. The addition and mixing of the liquid diluent to the unit dose is generally carried out in a dispensing appliance.

Examples of dispensing appliances of this type are coffee dispensers, where hot water is forced to percolate under pressure through a coffee powder bed contained in such unit dose before being served. Similar dispensing apparatuses exist for brewing tea. Another example of such dispensing apparatuses are soda machines, often used in fast food restaurants and other places where a consumer can fill its glass with a soda of his choice out of a selection of sodas, all available from the same dispenser. In such soda dispensers, syrups which are concentrated versions of the target soda contained in various pouches, are mixed with sparkling water upon dispensing the target soda thus formed. Such soda dispensers are advantageous because the syrups pouches are of much smaller dimensions than a corresponding ready to drink soda, and thus much cheaper to ship and to store.

Many brewers have been tempted to implement with fermented beverages the same dispensing solution as for sodas, but to date with very limited to no success. One reason for these repeated failures is probably that fermented beverages are more difficult to concentrate and preserve over long periods than soda syrups. Indeed, rapid degradation of the proteins contained in beer concentrates has been observed, which does not happen with soda syrups. Solutions have been proposed to solve said degradation problems, such as in EP-Patent Application No. 16163061.

An example of in situ production and subsequent dispensing of a MBFB comprises mixing an MBFB concentrate stored in one or several containers to be mixed with a carbonated diluent, typically carbonated water or a carbonated base beer characterized by rather neutral flavours profile. The carbonated diluent is a liquid comprising CO₂ at a concentration above saturation at room temperature and atmospheric pressure. It is generally stored or produced in situ at a pressure higher than atmospheric pressure, so that the CO₂ is dissolved in the liquid diluent. Upon mixing the carbonated diluent with the MBFB concentrate in a mixing chamber, a pressure drop may cause CO₂ to form froth and foam in the mixing chamber before dispensing. The amount of foam and froth formed depends on the CO₂-concentration, temperature and pressure of course, but it depends also on the composition of the MBFB concentrate the carbonate diluent is mixed with. For a dispensing appliance designed for dispensing a variety of MBFB's it is therefore not possible to tune the equipment in plant for forming a desired amount of froth applicable to all MBFB varieties. A system “one size fits them all” does not apply here.

It would be desirable to provide a dispensing appliance for dispensing MBFB by mixing a carbonated diluent with a variety of MBFB concentrates, which is capable of tuning the amount of froth produced during dispensing of a charge of MBFB into a vessel. The present invention proposes a solution meeting such objectives. These and other objects of this invention will be evident when viewed in light of the drawings, detailed description, and appended claims.

### SUMMARY OF THE INVENTION

The present invention is defined in the appended independent claims. Preferred embodiments are defined in the dependent claims. In particular, the present invention concerns a dispensing appliance for preparing and dispensing a malt based fermented beverage (MBFB) by mixing an MBFB concentrate with a carbonated diluent, said dispensing appliance comprising a mixing chamber for mixing the MBFB concentrate and the carbonated diluent, said mixing chamber being defined by walls and being divided by a mid-plane, M1, normal to a longitudinal axis, X, into an upper portion and a lower portion, said mixing chamber comprising:
(a) a concentrate opening located in the upper portion and being provided with a fixing device for fixing a container containing a MBFB concentrate;
(b) a diluent opening located in the upper portion and provided with a diluent connection to a source of carbonated diluent,
(c) an outlet oriented parallel to the longitudinal axis, X, and located in the lower portion, for discharging a MBFB composed of a mixture of MBFB concentrate and carbonated diluent,
(d) a core defined by a core surface and mounted in the chamber, such the core surface defines with the walls of the chamber a flow passage of width, w, measured normal to the core surface,
   Characterized in that, the core is movingly mounted in the chamber, such that it can be translated along the longitudinal axis, X, in order to control the width, w, of portions of the flow passage.

In order to drive the flow of MBFB concentrate out of a container into the mixing chamber, it is preferred that the dispensing appliance further comprises a gas tube connectable to a source of pressurized gas, arranged such that an outlet of said gas tube enters into fluid communication with the interior of the container containing the MBFB concentrate fixed to the fixing device.

In order to avoid sudden pressure drops in the flow passage, it is preferred that a geometry of the core is such that at least 70% of the core surface is substantially parallel to the walls of the chamber. In a preferred embodiment, the translation of the core along the longitudinal axis, X, towards the upper portion reduces the width, w, of the portion of the flow passage at the level of both concentrate opening and diluent opening. By translating the core along the longitudinal axis, X, the width, w, of the flow passage can preferably be varied locally between 0.1≤w≤10 mm, preferably between 0.5≤w≤5 mm, more preferably 1≤w≤3 mm. In some embodiments, a core surface may contact a wall of the mixing chamber and, for example, sealing one or more of the concentrate and/or diluent openings, and/or the outlet of the mixing chamber.

For a better control of the mixing ratio of concentrate to carbonated diluent, it is preferred that the concentrate opening and the diluent opening are both provided with volumetric flow controllers, such as volumetric pumps, or valves. The mixing of the MBFB concentrate and the carbonated diluent can be enhanced if the core surface and/or the walls of the mixing chamber are structured with protrusions and/or recesses. Such structured surfaces also reduce the formation of a turbulent flow.

The core can be translated along the longitudinal axis by one of the following preferred means:
A rack and pinion actuated either manually or with a motor,
A lever; or
An electric linear motor.

Alternatively, the position of the core can be set by the container when fixed to the fixing device, depending on the concentrate composition contained in said container. For example, a portion of the core surface facing directly the concentrate opening can be provided with a core coupling means suitable for reversibly coupling to a complementary coupling means mounted on a condensate container and extending out of an opening of said condensate container by a predefined distance. The predetermined distance defines the position of the core along the longitudinal axis, X, when the condensate container is fixed to the fixing device and when the complementary coupling means is reversibly coupled to the core coupling means at said portion of the core surface

The present invention concerns the dispensing appliance per se, but also the dispensing appliance ready for use, with a container containing a MBFB concentrate fixed to the fixing device, and a source of carbonated diluent, preferably carbonated water, connected to the diluent connection. If the MBFB is pressurized, then a source of pressurized gas, preferably CO₂, can be connected to the gas tube.

The present invention also concerns a method for controlling the amount of froth formed during dispensing of a malt based fermented beverage (MBFB), said method comprising the following steps:
(a) Providing a dispensing appliance as defined supra;
(b) Setting the core to an initial position with respect to the mid-plane, M1,
(c) Injecting MBFB concentrate and a carbonated diluent in a predetermined volume ratio into the mixing chamber; and dispensing the thus formed MBFB out of the outlet into a container;
(d) Assessing the level of froth formed in the MBFB contained in the container,
(e) If the level of froth does not correspond to a desired level, translating the core along the longitudinal direction, X, and
(f) Repeating steps (a) to (d) until the desired level of froth is reached.

### BRIEF DESCRIPTION OF THE FIGURES

For a fuller understanding of the nature of the present invention, reference is made to the following detailed description taken in conjunction with the accompanying drawings in which:

FIG. 1: shows front view and side view of dispensing appliances according to the present invention.

FIG. 2: shows a mixing chamber according to the present invention with the core at three different positions.

FIG. 3: shows an alternative mixing chamber according to the present invention with the core at three different positions.

FIG. 4: shows the saturation concentration of CO₂ in water and ethanol (EtOH) depending on pressure at a temperature of 298° K.

FIG. 5: shows (a) a perspective cut view of a mixing chamber according to the present invention and (b) to (d) alternative mixing chamber designs according to the present invention.

FIG. 6: shows various embodiments of translating mechanisms for translating the core along the longitudinal axis.

FIG. 7: shows an embodiment for controlling the position of the core as a function of the composition of the concentrate loaded in the dispensing appliance.

### DETAILED DESCRIPTION OF THE INVENTION

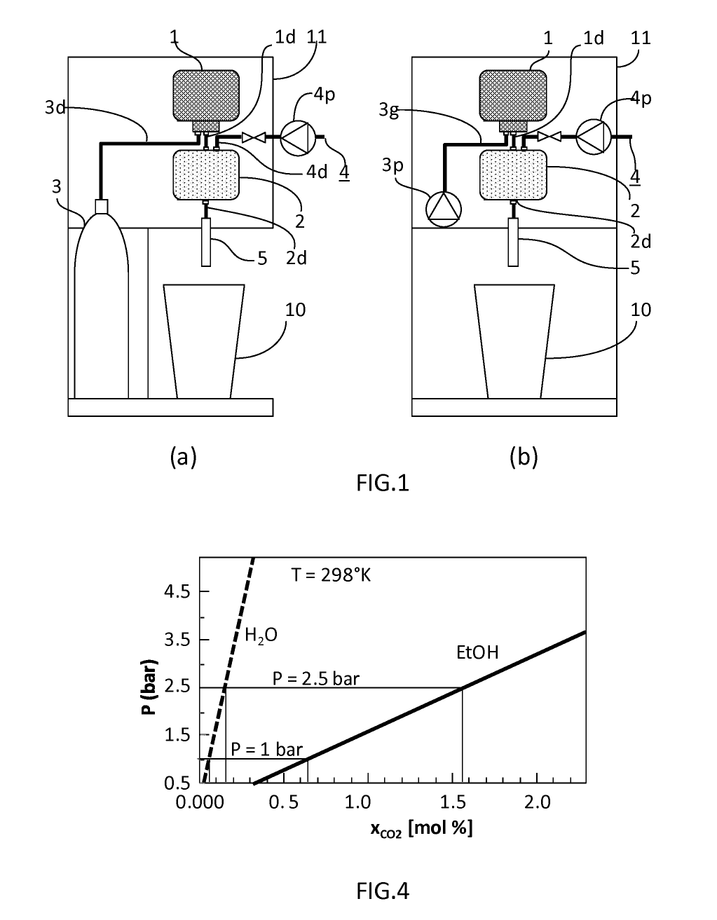

As shown in FIG. 1, a dispensing appliance according to the present invention is used as follows. A container (1) contains a malt based fermented beverage (MBFB) concentrate and is in fluid communication with a mixing chamber (2). A source (4) of carbonated diluent is in fluid communication with the same mixing chamber. After mixing the MBFB-concentrate with the carbonated beverage, the thus produced MBFB is dispensed out of an outlet (2d) of the mixing chamber, through a dispensing tube (5) into a vessel (10), which can be a glass or a jar. In particular, the gist of the present invention concerns the mixing chamber (2) for mixing the MBFB concentrate and the carbonated diluent. The mixing chamber is defined by walls and is divided by a mid-plane, M1, normal to a longitudinal axis, X, into an upper portion and a lower portion: The mixing chamber further comprises:
(a) a concentrate opening (1d) located in the upper portion and provided with a fixing device for fixing a container containing a MBFB concentrate;
(b) a diluent opening (4d) located in the upper portion and provided with a diluent connection for connecting to a source of carbonated diluent,
(c) an outlet (2d) oriented parallel to the longitudinal axis, X, and located in the lower portion, for discharging a MBFB composed of a mixture of MBFB concentrate and carbonated diluent,
(d) a core (2c) defined by a core surface and mounted in the chamber, such that the core surface defines with the walls of the chamber a flow passage (2p) of width, w, measured normal to the core surface.

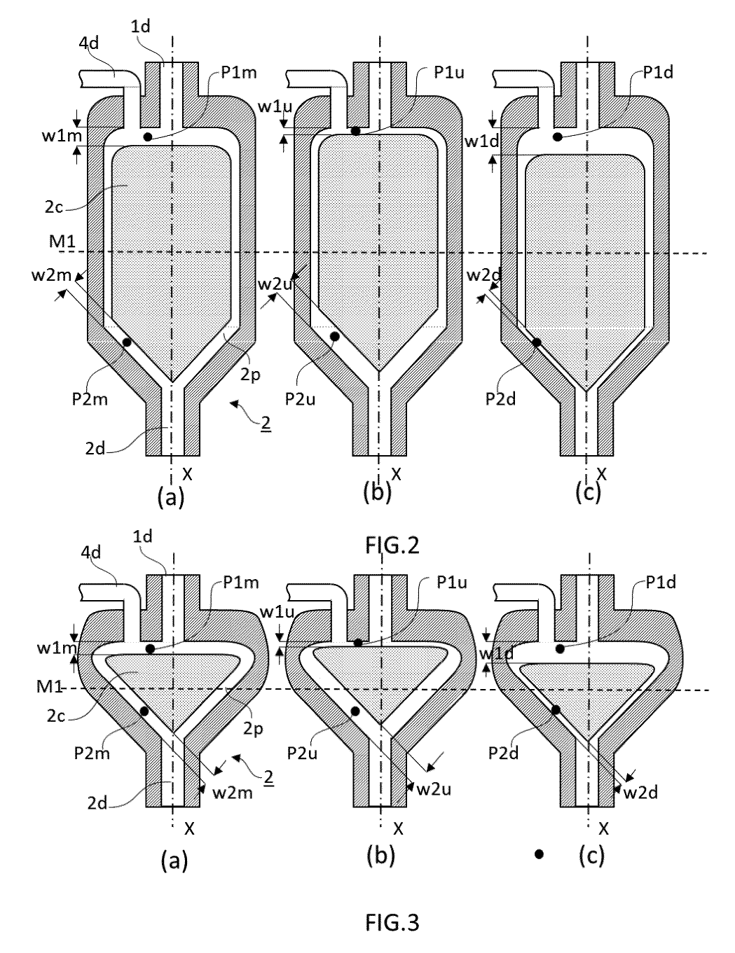

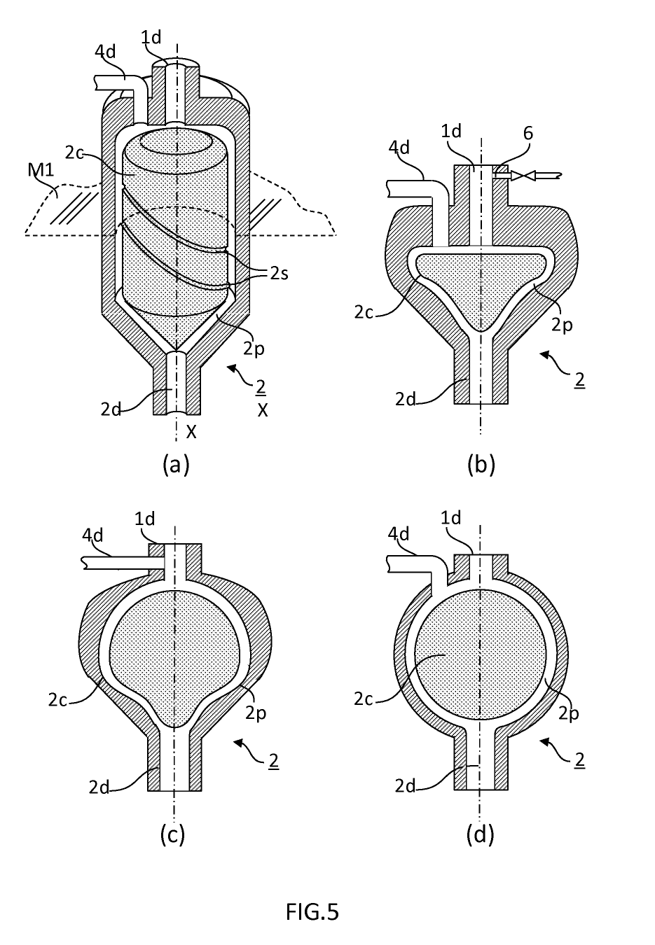

As illustrated in FIGS. 2 and 3, the core is movingly mounted in the chamber, such that it can be translated along the longitudinal axis, X, in order to control the width, w, of portions of the flow passage. FIGS. 2 and 3 show the widths of the flow passage at different positions and with different configurations of the core. three different positions of the core with respect to the mid-plane M1 are represented in FIGS. 2 and 3: (a) a centred position, wim, (b) an upper position, wiu, and (c) a lower position, wid, with, with i=1 or 2 wherein i=1 indicates a portion of the flow passage located at the upper portion and, i=2 indicates a portion of the flow passage located at the lower portion. The corresponding pressures Pij, with i=1 or 2, and j=m, u, or d, as defined above with respect to the widths, are also indicated in the Figures.

When a single container (1) containing an MBFB concentrate is illustrated in FIG. 1, more than one container can be used, each containing different components in a concentrated form. One container can also comprise several chambers, each containing corresponding concentrated components. The present invention is not restricted to the number and forms of the containers. The MBFB concentrate is in a liquid form (or pasty) so that it can flow under pressure from the container into the mixing chamber. The MBFB concentrate may comprise solid particles, but they must be in suspension in a liquid medium. A container may contain an amount of MBFB concentrate sufficient for a single dispensing operation into one glass (single dose container) or, alternatively, it may contain an amount of MBFB concentrate sufficient for several dispensing operations (=multi-doses container). The latter is more economical in terms of packaging cost per unit volume of MBFB concentrate.

The MBFB concentrate contained in the container (1) can be obtained by producing a fermented beverage in a traditional manner (e.g., for a beer, by brewing it in any fashion known in the art), followed by concentrating the thus produced fermented beverage. Concentration occurs by removing, on the one hand, a fraction of the water contained therein and, on the other hand, a fraction of the ethanol contained therein. A substantial amount of both water and ethanol can be removed from the beverage by filtration, micro-filtration, ultra-filtration, or nano-filtration, using appropriate membranes well-known to a person skilled in the art.

The flow of MBFB concentrate into the mixing chamber can be driven by gravity only, and controlled by means of a valve (not shown). But this embodiment is not preferred because it would impose the flow of carbonated diluent to be driven by gravity too, in order to not creating sharp pressure drops at the level of the diluent opening into the mixing chamber. It is therefore preferred to drive the flow of MBFB concentrate either with a pump (not shown) or by pressurizing the interior of the container by means of a source of pressurized gas, preferably of pressurized CO₂. The pressurized gas can be stored in a pressure canister (3) as shown in FIG. 1(a). The gas can be pressurized with a pump (3p) as shown in FIG. 1(b). Alternatively, if available, a pressurized gas can be available from a network. It is important to be able to control the volume ratio of MBFB concentrate and carbonated diluent fed into the mixing chamber. For this reason, a valve (not shown) can be provided to control the flow rate of MBFB concentrate and carbonated diluent. Alternatively a volumetric flow controller such as a volumetric pump can be used for controlling the volumes of MBFB concentrate and carbonated diluent fed into the mixing chamber.

The carbonated diluent is a liquid diluent containing an amount of CO₂ higher than the solubility of CO₂ in said liquid diluent at room temperature and at atmospheric pressure. This means that the carbonated diluent is sparkling with CO₂ bubbles at room temperature and atmospheric pressure. The liquid diluent is preferably water. Other liquid diluents, however, can be used instead of water. In particular, a beer with a rather neutral flavours profile can be used as carbonated diluent. A flavoured aqueous solution can also be used, with for example, fruity flavours like cherries, peach, and the like to produce fruity beers. Water has the great advantage that the source (4) of carbonated diluent can be a water tap present in all households, equipped with a carbonation station. If a pressurized CO₂ cartridge (3) is used to drive the flow of MBFB concentrate into the mixing chamber, the same pressurized CO₂ cartridge can be used for carbonating tap water. Filters can be used to treat the water coming out of the tap if the quality is not satisfactory. If a carbonated diluent other than carbonated water is used, it can be stored in a vessel (not shown).

As can be seen in FIG. 4, the solubility of CO₂ in water increases very steeply with increasing pressure (dashed curve) with about 0.1 to 0.2 mol. % CO₂ at 2.5 bar. CO₂ has a higher solubility in pure ethanol (EtOH) (=solid curve) with about 1.6 mol. % at the same pressure of 2.5 bar. Any aqueous diluent comprising ethanol would yield a CO₂ solubility comprised between these two curves. The curves of FIG. 4 show that any variation of pressure in a carbonated diluent may result in CO₂ bubbling or dissolving. This is particularly true for water as liquid diluent, because the straight dashed line in FIG. 4 has a very steep slope. This is critical with MBFB's because unlike sodas, once formed foam remains a long time.

Entry of the carbonated diluent and MBFB concentrate into a mixing chamber is a critical step in dispensing appliances because a great pressure drop may arise in the mixing chamber, leading to the premature formation of froth even before the beverage has been dispensed into a vessel (10). The design of the mixing chamber could be optimized for one type of MBFB, but customers are not satisfied with a dispensing appliance able to dispense only a very limited number of MBFB's. Customers claim the liberty of creating new beverages from different concentrates or of choosing a MBFB out of a large selection of products. Each MBFB concentrate and each carbonated diluent will react differently upon mixing in a mixing chamber and one recipe will lead to the formation of more froth than desirable whilst another recipe will yield insufficient froth formation.

As illustrated in FIGS. 2&3, with the core (2c) in the mixing chamber, which is movable along the longitudinal axis, X, the width, w, of the flow passage (2d) can be varied at selected portions of said flow passage. The width, w, is not necessarily, and is generally never, constant over the whole of the flow passage from the concentrate and diluent openings (1d, 4d) to the outlet (2d) of the mixing chamber. The design of the flow passage must ensure that no sudden pressure drop in the flowing liquid occurs before it reaches an outlet of the dispensing tube (5) and is poured into a vessel (10) where foam formation is desired. This can be achieved by avoiding any sharp steps in the passage flow. The flow passage can be locally tapered, but it is preferred that at least 70% of the core surface is substantially parallel to the walls of the chamber. It is also preferred that the concentrate opening (1d) and diluent opening (4d) be located at the mixing chamber walls such that the translation of the core along the longitudinal axis, X, towards the upper portion reduces the width, w, of the portion of the flow passage at the level of both concentrate opening and diluent opening. The embodiments illustrated in FIGS. 2, 3, 5, and 6 are illustrative of this preferred embodiment. Both condensate and diluent opening are located at a same wall facing an upper surface of the core surface which, with the exception of FIG. 5(c)&(d); is substantially planar and normal to the longitudinal axis, X. The term “upper” is defined with respect to the mid-plane, M1, in the same way as the upper portion of the mixing chamber is defined. In the Figures, the longitudinal axis, X, is vertical and the term “upper” corresponds to “vertically above”, but since the mixing chamber is pressurized, it is not mandatory that the longitudinal axis, X, be vertical. In this case, the expression “upper portion” refers to the portion of the mixing chamber comprising the condensate and diluent openings (1d, 4d), which Is separated at the level of the (virtual) mid-plane, M1, from the “lower portion”, which comprises the outlet (2d) of the mixing chamber.

It is also preferred that the longitudinal axis, X, passes through the outlet (2d) of the mixing chamber. The walls of the mixing chamber, excluding the openings and outlets, preferably define a geometry of revolution about the longitudinal axis, X. All sharp edges in the mixing chamber are preferably rounded to reduce pressure drops as the flow passes such ridges (the figures are schematic and comprise many sharp edges, which are preferably avoided in practice). The lower surface of the core (i.e., the portion of core surface facing the outlet (2d) of the mixing chamber) preferably has a tapered geometry. The tapered geometry can be conical with the apex of the cone facing the outlet of the mixing chamber, in alignment with the longitudinal axis, X, as illustrated in FIGS. 2&3. Alternatively, the tapered geometry can include a pear shape, more complex shapes, like a pear like shape as illustrated in FIG. 5(c), or a volume of revolution generated by a curved generator, as shown in FIG. 5(b). The core may even have a spherical geometry as illustrated in FIG. 5(d), or elliptical or the like.

By locally varying the width, w, of the flow passage (2p) the pressure of the liquid mixture formed by the condensate and the carbonated diluent can be controlled. This is important for controlling the amount of CO₂ bubbling and, more importantly, the location where CO₂ starts bubbling and forming froth. As shown in FIGS. 2&3, the pressure, Pij, in the liquid varies locally with the width, wij, of the flow passage, wherein i=1 or 2, referring to two positions in the flow passage, 1 being located in the upper portion, and 2 in the lower portion, and wherein j=m, u, or d depending on whether the core is m=centred on, (b) up or (c) down with respect to the mid-plane, M1. FIGS. 2(a)&3(a) show embodiments wherein the core is centred on the mid-plane, M1. This configuration corresponds to the position wherein the width, w, of the flow path is most uniform (i.e., having lowest variations). With a width, w1m, of the flow passage in the upper portion, adjacent to the condensate and diluent openings, and a width, w2m, in the lower portion of the flow passage, the pressure in the flowing liquid is P1m and P2m.

In FIGS. 2(b)&3(b), the core is translated along the longitudinal axis, X, in the direction of the upper portion, reducing the width, w1u<w1m, at the upper portion compared with a centred core, and the width, w2u>w2m, at the lower portion increases accordingly. The pressure, P1u>P1m, at the upper portion is therefore higher than with a centred core. The pressure, P2u, decreases, and formation of some CO₂ bubbles in the mixing chamber is possible, before the MBFB is dispensed out of the dispensing tube (5).

In FIGS. 2(c)&3(c), the core is translated along the longitudinal axis, X, in the direction of the lower portion, increasing the width, w1d>w1m, but reducing the width, w2d<w2m, at the lower portion compared with a centred core. It follows that the pressures P1d and P2d remain high throughout the flow passage of the mixing chamber, and the pressure drops only when the MBFB reaches the dispensing tube (5) and is dispensed.

As explained above, the width, w, of the flow passage can be varied by translating the core along the longitudinal axis. In general the width of the flow passage can be varied between 0.1≤w≤10 mm, preferably between 0.5≤w≤5 mm, more preferably 1≤w≤3 mm. In some instances, the core may seal the condensate and diluent openings or, alternatively, the outlet of the mixing chamber, with a width, w, which can reach locally 0 mm (i.e., the core surface contacts a wall of the mixing chamber).

With the translation of the core, the level of froth or foaming of the MBFB being dispensed can be controlled. This level of froth depends of course on the taste of the users. It also depends on parameters that are beyond the control of the users and of the appliances manufacturer. In particular, it depends inter alia:
on the pressures of the MBFB concentrate and of the carbonated diluent as they flow into the mixing chamber,
on the CO₂ concentration in the carbonated diluent,
on the CO₂ concentration in the MBFB concentrate (if the concentrate container is pressurized with CO₂, some CO₂ will dissolve in the MBFB concentrate),
on the liquid diluent with properties such as the CO₂ saturation concentration of said liquid diluent and the pressure dependence of said CO₂ saturation concentration;
on the composition of the MBFB concentrate,
on the temperature in the mixing chamber.

Each new MBFB composition is characterized by its own set of values of the foregoing parameters. All these values may vary over ranges which, at least to date, are too broad and complex for allowing an auto-regulation of the pressures as a function of a desired level of foaming. It follows that a dispensing appliance with set dimensions of the mixing chamber width, can only satisfactorily dispense a restricted selection of MBFB's, with agreeable levels of foam. With its moving core, the present invention permits the tuning of the properties of the dispensing appliance, so that the optimal dispensing conditions can be defined allowing the dispensing of a large variety of MBFB's with the required level of foam formation. For each new MBFB composition, the optimal position of the core must be determined in order to dispense said MBFB with the desired amount of foam. Once the optimal position of the core has been found, it is set and it needs not be moved again as long as the same MBFB composition is being dispensed (and as long as there are no variations in temperature, CO₂ concentration, and pressures in the carbonated diluent and MBFB concentrate). When a new MBFB composition is desired, the optimal core position must be determined again, as explained below. A data base can be established giving optimal core position ranges suitable for a selection of pre-established MBFB compositions.

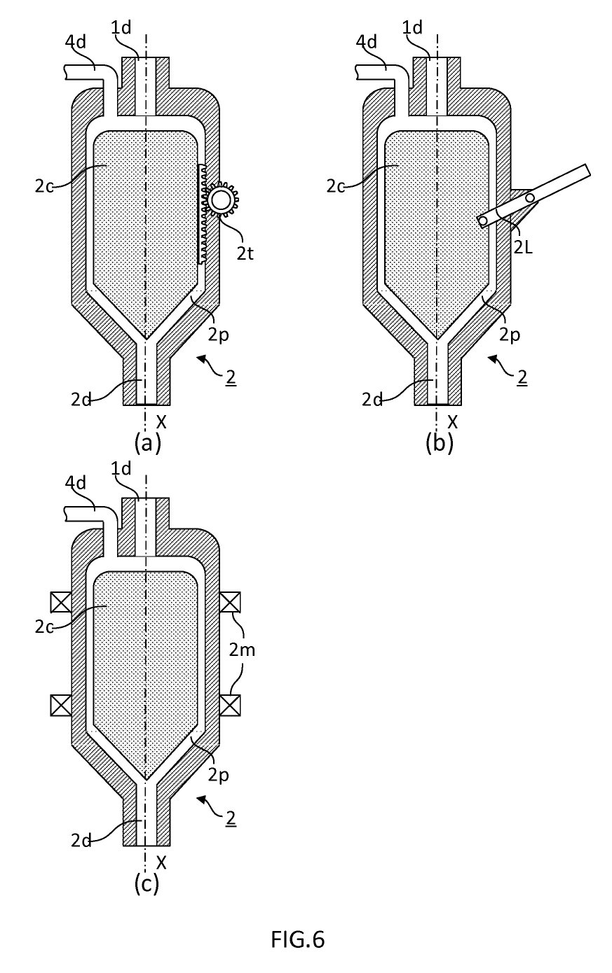

The core can be translated along the longitudinal axis, X, by any known manner. For example, as shown in FIG. 6(a), the core can be coupled to a rail provided with a rack. A pinion (2t) can be coupled to the track and can be actuated by hand or with a motor. In an alternative embodiment, the core can be translated manually with a lever, as illustrated in FIG. 6(b). In a preferred embodiment illustrated in FIG. 6(c), an electric linear motor can be used, with coils (2m) wound around the mixing chamber, and the core comprising magnets. The foregoing translation mechanisms are cited only as illustrative examples, and other mechanisms for translating the core can be used instead.

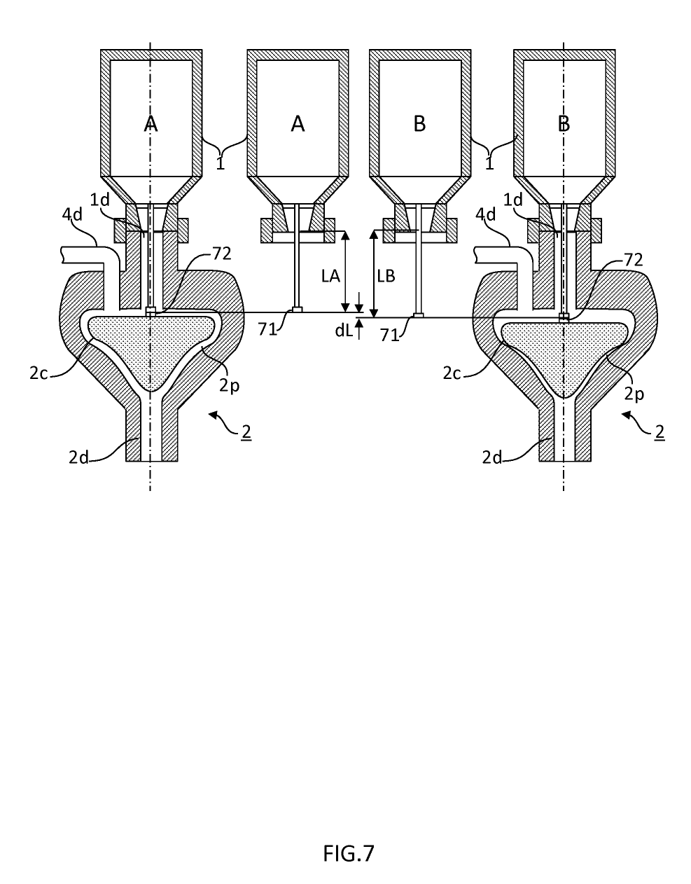

In an alternative embodiment, the position of the core can be controlled by the container (1) containing the concentrate. Because the level of froth formed upon dispensing a MBFB out of a dispensing appliance according to the present invention depends strongly on the composition of the concentrate, a pre-set position of the core may be associated to a given concentrate composition. For implementing this embodiment, all other dispensing parameters must of course be according to pre-set conditions, including the carbonated diluent, pressures at the source of carbonated diluent and in condensate container, etc. For example, as illustrated in FIG. 7, a portion of the core surface facing directly the concentrate opening (1d) can be provided with a coupling means (72) suitable for reversibly coupling to a complementary coupling means (71) mounted on a condensate container (1). The complementary coupling means extends out of an opening of the concentrate container, at a given distance, LA, LB, from said opening. The distance, LA, LB, is pre-defined in plant depending on the type of concentrate, A, B, contained in the concentrate container. When the concentrate container (1) is fixed to the fixing device of the dispensing appliance, and the complementary coupling means is reversibly coupled to the core coupling means, the distance LA, LB, defines the position of the core along the longitudinal axis, X.

The complementary coupling means can be mounted at one end of a stem of predefined length, LA, LB. The stem needs not be rigid, depending on the type of (complementary) coupling means (71, 72) used. For example, the core and complementary coupling means (71, 72) can be magnets. In this case, the stem can be flexible, and can be replaced by a string. The core and complementary coupling means (71, 72) can be a male/female threaded screw, which could possibly combine with a fixing device between the concentrate container and the mixing chamber also comprising a similar thread. By fixing a concentrate container by screwing it over the threaded fixing device of the dispensing appliance, the complementary fixing means (71) would simultaneously engage the core fixing means (72). The same would happen when unscrewing an empty container, which action would simultaneously disengage the complementary coupling means from the core coupling means.

FIG. 7 illustrates two concentrate containers containing a concentrate A and a concentrate B. The distance, LB, for concentrate B is longer than the distance, LA, for concentrate A. Consequently, when the container of concentrate B is fixed to the fixing device of the dispensing appliance, the core is pushed further forwards the lower portion of the mixing chamber than when a container of concentrate A is mounted instead, with a distance LA<LB. Consequently, a higher back pressure is generated in the mixing chamber when a condensate B is being mixed with a carbonated diluent, than when a concentrate A is used instead and CO₂ remains dissolved in the mixture for a longer period.

As illustrated schematically in FIG. 5(a), the core surface may be provided with structured elements (2s) such as protrusions or recesses in the form of continuous or discontinuous grooves or ridges, discrete protrusions or recesses in the shape of dots, beans, baffles, protrusions with a convex or concave geometry facing the upper portion of the mixing chamber, and the like. A structured surface of the core can help directing the flow of liquids in a desired pattern and enhance mixing of the carbonated diluent and MBFB concentrate. Care must be taken, when designing such structured surface, not to impair the cleaning of the mixing chamber after use. Alternatively, or additionally, the walls of the mixing chamber can be structured as described supra with respect to the core (not shown in the Figures).

The mixing chamber must be cleaned regularly. This can be done by rinsing it with a rinsing solution, such as water, possibly with a detergent, after a given number of dispensing operations. If the liquid diluent is water, it can be injected through the diluent opening (4d) without CO₂, to thoroughly rinse the mixing chamber. Alternatively, an additional rinsing opening (6) can be provided in the mixing chamber, and connected to a source of rinsing liquid. This rinsing opening is devoted exclusively to rinsing and detergents can be used. The rinsing opening (6) can be located at a wall of the mixing chamber facing the core or, as illustrated in FIG. 5(b), it can be located at a wall of the mixing chamber forming a tubular fluid communication between the fixing device and the core, without facing the core directly. This embodiment is interesting because the rinsing solution such tubular fluid connection. A valve ensures that the MBFB concentrate does not flow out through the rinsing opening. As illustrated in FIG. 5(c), the diluent opening can also be located in a wall of such tubular fluid connection.

The present invention concerns the dispensing appliance per se. It also concerns, of course, the dispensing appliance with a container containing a MBFB concentrate fixed to the fixing device, as well as with a source of carbonated diluent, preferably carbonated water, connected to the diluent connection. Thus loaded and connected the dispensing appliance of the present invention, is operational and can be used to dispense an MBFB with an optimal amount of foam. If the dispensing appliance comprises electrically driven functions, it must of course be connected to a source of power. For example, the dispensing appliance may comprise a cooling unit for cooling the carbonated diluent, electrically driven pumps, flow controllers, valves, etc.

The present invention also concerns a method for controlling the amount of froth formed during dispensing of a malt based fermented beverage (MBFB), said method comprising the following steps:
(a) Providing a dispensing appliance as discussed supra, with a container containing a MBFB concentrate fixed to the fixing device, and with a source of carbonated diluent, connected to the diluent connection;
(b) Setting the core to an initial position with respect to the mid-plane, M1,
(c) Injecting MBFB concentrate and a carbonated diluent in a predetermined volume ratio into the mixing chamber, and dispensing a small volume of the thus formed MBFB out of the outlet into a container (10);
(d) Assessing the level of froth formed in the MBFB contained in the container,
(e) If the level of froth does not correspond to a desired level, translating the core along the longitudinal direction, X, and
(f) Repeating steps (a) to (d) until the desired level of froth is reached.

These operations seem cumbersome, but they are rapidly carried out and it is quite easy to find an optimal position of the core providing the desired level of foam, with very limited waste of beverage. Once the right position of the core is found, it can be maintained at said position as long as the same components and dispensing conditions are used.

| REF | DESCRIPTION |
|---|---|
| 1 | MBFB concentrate container |
| 1d | concentrate opening |
| 2 | mixing chamber |
| 2c | core |
| 2d | Outlet of mixing chamber |
| 2p | flow passage between core surface and mixing |
| | chamber walls |
| 2s | structured surface of the core |
| 3 | Source of pressurized gas to MBFB concentrate container |
| 3g | tube from source of pressurized gas to MBFB concentrate |
| | container |
| 3p | Pump for pressurizing gas to MBFB concentrate container |
| 4 | source of carbonated diluent |
| 4d | diluent opening |
| 4p | Pump for pressurizing carbonated diluent |
| 5 | dispensing tube |
| 6 | rinsing opening |
| 10 | Vessel for collecting the in situ created beverage |
| 11 | Dispensing apparatus |
| 71 | Complementary coupling means |
| 72 | Core coupling means |
| M1 | mis-plane normal to longitudinal axis, X |
| P1d | liquid pressure at the upper portion with the core |
| | lowered with respect to the mid-plane M1 |
| P1m | liquid pressure at the upper portion with the core |
| | centred with respect to the mid-plane M1 |
| P1u | liquid pressure at the upper portion with the core |
| | raised with respect to the mid-plane M1 |
| P2d | liquid pressure at the lower portion with the core |
| | lowered with respect to the mid-plane M1 |
| P2m | liquid pressure at the lower portion with the core |
| | centred with respect to the mid-plane M1 |
| P2u | liquid pressure at the lower portion with the core |
| | raised with respect to the mid-plane M1 |
| w1d | flow passage width at the upper portion with the core |
| | lowered with respect to the mid-plane M1 |
| w1m | flow passage width at the upper portion with the core |
| | centred with respect to the mid-plane M1 |
| w1u | flow passage width at the upper portion with the core |
| | raised with respect to the mid-plane M1 |
| w2d | flow passage width at the lower portion with the core |
| | lowered with respect to the mid-plane M1 |
| w2m | flow passage width at the lower portion with the core |
| | centred with respect to the mid-plane M1 |
| w2u | flow passage width at the lower portion with the core |
| | raised with respect to the mid-plane M1 |
| X | longitudinal axis normal to plane M1 |

1. A dispensing appliance for preparing and dispensing a malt based fermented beverage (MBFB) by mixing an MBFB concentrate with a carbonated diluent, said dispensing appliance comprising a mixing chamber (2) for mixing the MBFB concentrate and the carbonated diluent, said mixing chamber being defined by walls and being divided by a mid-plane, M1, normal to a longitudinal axis, X, into an upper portion and a lower portion, said mixing chamber comprising:
(a) a concentrate opening (1d) located in the upper portion and being provided with a fixing device for fixing a container containing an MBFB concentrate;
(b) a diluent opening (4d) located in the upper portion and provided with a diluent connection to a source of carbonated diluent,
(c) an outlet (2d) oriented parallel to the longitudinal axis, X, and located in the lower portion, for discharging an MBFB composed of a mixture of MBFB concentrate and carbonated diluent,
(d) a core (2c) defined by a core surface and mounted in the chamber, such the core surface defines with the walls of the chamber a flow passage (2p) of width, w, measured normal to the core surface,
wherein the core is movingly mounted in the chamber, such that it can be translated along the longitudinal axis, X, in order to control the width, w, of portions of the flow passage.

2. The dispensing appliance according to claim 1, further comprising a gas tube connectable to a source of pressurized gas, arranged such that an outlet of said gas tube enters into fluid communication with the interior of a container containing an MBFB concentrate fixed to the fixing device.

3. The dispensing appliance according to claim 1, wherein the core can be translated along the longitudinal axis by one of the following means:
A rack and pinion actuated either manually or with a motor,
A lever; or
An electric linear motor.

4. The dispensing appliance according to claim 1, wherein a geometry of the core is such that at least 70% of the core surface is substantially parallel to the walls of the chamber.

5. The dispensing appliance according to claim 4, wherein the translation of the core along the longitudinal axis, X, towards the upper portion reduces the width, w, of the portion of the flow passage at the level of both concentrate opening and diluent opening.

6. The dispensing appliance according to claim 1, wherein the width, w, of the flow passage can be varied by translating the core between 0.1<w<1 0 mm, preferably between 0.5<w<5 mm, more preferably 1<w<3 mm.

7. The dispensing appliance according to claim 1, wherein the concentrate opening and the diluent opening are both provided with volumetric flow controllers.

8. The dispensing appliance according to claim 1, wherein the core surface and/or the walls of the mixing chamber are structured (2s) with protrusions and/or recesses.

9. The dispensing appliance according to claim 1, wherein a container containing a MBFB concentrate is fixed to the fixing device, and a source of carbonated diluent, preferably carbonated water, is connected to the diluent connection.

10. The dispensing appliance according to claim 2, wherein a source of pressurized gas, preferably CO₂, is connected to the gas tube.

11. The dispensing appliance according to claim 1, wherein a portion of the core surface facing directly the concentrate opening is provided with a core coupling means (72) suitable for reversibly coupling to a complementary coupling means (71) mounted on a condensate container (1) and extending out of an opening of said condensate container by a predefined distance defining the position of the core along the longitudinal axis, X, when the condensate container is fixed to the fixing device and when the complementary coupling means is reversibly coupled to the core coupling means at said portion of the core surface.

12. A method for controlling the amount of froth formed during dispensing of a malt based fermented beverage (MBFB), said method comprising the following steps:
(a) Providing a dispensing appliance according to claim 9;
(b) Setting the core to an initial position with respect to the mid-plane, M1;
(c) Injecting MBFB concentrate and a carbonated diluent in a predetermined volume ratio into the mixing chamber; and dispensing the thus formed MBFB out of the outlet into a container;
(d) Assessing the level of froth formed in the MBFB contained in the container;
(e) If the level of froth does not correspond to a desired level, translating the core along the longitudinal direction, X; and
(f) Repeating steps (a) to (d) until the desired level of froth is reached.

13. A method for controlling the amount of froth formed during dispensing of a malt based fermented beverage (MBFB), said method comprising the following steps:
(a) Providing a dispensing appliance according to claim 11;
(b) Setting the core to an initial position with respect to the mid-plane, M1;
(c) Injecting MBFB concentrate and a carbonated diluent in a predetermined volume ratio into the mixing chamber; and dispensing the thus formed MBFB out of the outlet into a container;
(d) Assessing the level of froth formed in the MBFB contained in the container;
(e) If the level of froth does not correspond to a desired level, translating the core along the longitudinal direction, X; and
(f) Repeating steps (a) to (d) until the desired level of froth is reached.

14. The dispensing appliance according to claim 2, wherein the core can be translated along the longitudinal axis by one of the following means:
A rack and pinion actuated either manually or with a motor,
A lever; or
An electric linear motor.

15. The dispensing appliance according to claim 14, wherein a geometry of the core is such that at least 70% of the core surface is substantially parallel to the walls of the chamber.

16. The dispensing appliance according to claim 15, wherein the translation of the core along the longitudinal axis, X, towards the upper portion reduces the width, w, of the portion of the flow passage at the level of both concentrate opening and diluent opening.

17. The dispensing appliance according to claim 16, wherein the width, w, of the flow passage can be varied by translating the core between 0.1<w<1 0 mm, preferably between 0.5<w<5 mm, more preferably 1<w<3 mm.

18. The dispensing appliance according to claim 17, wherein the concentrate opening and the diluent opening are both provided with volumetric flow controllers.

19. The dispensing appliance according to claim 18, wherein the core surface and/or the walls of the mixing chamber are structured (2s) with protrusions and/or recesses.

20. The dispensing appliance according to claim 19, wherein a container containing a MBFB concentrate is fixed to the fixing device, and a source of carbonated diluent, preferably carbonated water, is connected to the diluent connection.
